(19) United States
(12) Patent Application Publication
(10) Pub. No.: US 2007/0203917 A1
(43) Pub. Date: Aug. 30, 2007

(54) Communication System And Method For Implementing Online File Storage Based On An Instant Messaging Platform

(75) Inventors: Qingsheng Du, Shenzhen (CN); Zhen Wei, Shenzhen (CN); Hongzhan Xia, Shenzhen (CN); Shuangquan Yu, Shenzhen (CN)

Correspondence Address: HARNESS, DICKEY & PIERCE, P.L.C., P.O. BOX 828, BLOOMFIELD HILLS, MI, 48303, US

(73) Assignee: TENCENT TECHNOLOGY (SHENZHEN) COMPANY LIMITED, Shenzhen (CN)

(21) Appl. No.: 11/680,192

(22) Filed: Feb. 28, 2007

Related U.S. Application Data
(63) Continuation of application No. PCT/CN05/01371, filed on Aug. 31, 2005.

(30) Foreign Application Priority Data
Aug. 31, 2004 (CN) 200410051322.5
Aug. 31, 2004 (CN) 200410051318.9
Sep. 30, 2004 (CN) 200410051766.9

(51) Int. Cl. G06F 7/00

(52) U.S. Cl. 707/10

(57) ABSTRACT

Embodiments of the present invention disclose a communication system for implementing online file storage based on an instant messaging (IM) platform and a method thereof, the method includes: an IM client transmits an online storage operation request of a file to an online file storage access server; the online file storage access server interacts with the online file storage server to implement the online storage operation according to the online storage operation request, and returns the result of operation to the IM client. By using the communication system and method, a user can implement various online storage operations such as file storing, deleting, sharing, copying and the like via the existed IM client, without downloading a special online file storage client. The operation is simple, and functions and storing and reading speeds the same as the ones provided by the online storage in the special client-based mode can be achieved.

### CROSS-REFERENCE TO RELATED APPLICATIONS

This application is a continuation of International Application No. PCT/CN2005/001371 filed on Aug. 31, 2005. This application claims the benefit of Chinese Application Nos. 200410051322.5 filed on Aug. 31, 2004, 200410051318.9 filed on Aug. 31, 2004, and 200410051766.9 filed on Sep. 30, 2004. The disclosures of the above applications are incorporated herein by reference.

### FIELD

The present disclosure relates to the online storage technology, particularly to a communication system and method for implementing online file storage based on an instant messaging (IM) platform.

### BACKGROUND

The statements in this section merely provide background information related to the present disclosure and may not constitute prior art.

### Online storage is a remote storage service based on a Client/Server (C/S) mode, mainly providing basic file services such as storing, sharing, transferring, copying, etc.

There are two kinds of mode in the existing online storage: a Web mode and a special client-based mode. Among the two modes, the online storage in the Web mode usually bound with an e-mail box is easily accepted by users because it can be used like an e-mail box; and the online storage in the special client-based mode is the online storage service based on a special client software, which is usually bound with the Windows Explorer and is easily to be operated by users, and the functions and speed of the online storage in the special client-based mode can be guaranteed.

The existing remote online storages, however, all have some drawbacks. For example, the online storage in the Web mode provides bad basic file operations, because the steps of the basic file operations are fussy, and the functions and speed are all limited; while the online storage in the special client-based mode can be used only after the special online storage client is downloaded, holding back the popularity of the online storage service.

### SUMMARY

An embodiment of the present invention provides a communication system for implementing online file storage based on an IM platform, through which a user can implement online storage operations on files through simple operations and gain functions, storing and reading speeds the same as the ones provided by the online file storage in the special client-based mode, without downloading a special online file storage client.

An embodiment of the present invention provides a method for implementing such basic operations as file storing, deleting, copying, and so on in an online file storage based on an IM platform, to enable a user to implement the online storage operations through simple operations.

An embodiment of the present invention provides a method for sharing files in an online file storage based on an IM platform, to enable a user to share files in an online file storage with other IM friends through simple operations.

An embodiment of the present invention provides a method for a user virtually copying files shared by other users to other users own online file storage, saving storing spaces for files and accelerating the speed for copying files at the same time.

An embodiment of the present invention provides a communication system and a method for playing audio video (AV) files online based on an IM platform, to enable a user to online listen to or watch AV files through the online file storage communication system, greatly satisfying the requirements of users for online multimedia services.

A communication system for implementing online file storage based on an IM platform includes: an IM client accessing a communication network and an online file storage access server accessing the communication network, and an online file storage server accessing the online file storage access server;

the IM client is used to provide an online file storage operation interface;

the online file storage access server is used to parse an IM protocol, verify a user online storage identifier and process a user request logic from the IM client;

the online file storage server is used to store files in the online file storage and directory information, and process a file request from the online file storage access server.

A communication system for online playing AV files in an online file storage based on an IM platform, includes: an IM client accessing a communication network and an online file storage access server accessing the communication network, an online file storage server accessing the online file storage access server, and a flow media server accessing the communication network and the online file storage access server;

the IM client is used to provide an online file storage operation interface via which a user chooses online playing operations, and start a local media player to play the files in the list;

the online file storage server is used to store files in the online file storage and the user data;

the online file storage access server is used to process an online playing request of the user;

the flow media server is used to temporarily store AV files to be played online by the IM user, generate and return a playing list to the online file storage access server.

A method for implementing online file storage in a communication system implementing online file storage based on an IM platform includes:

the IM client transmits a file request to an online file storage access server, after an IM user chooses to implement a file operation on a file in the online file storage via an IM client;

the online file storage access server acquires user data of the IM user according to the received file request from the online file storage user data server;

the online file storage access server interacts with the online file storage server according to the acquired user data, implements the file requested by the user, and updates the user data of the IM user in the online file storage user data server according to a result of the file operation;

the online file storage access server returns the result of the file operation to the IM client.

A method for sharing files in a communication system implementing online file storage based on an IM platform includes:

pre-setting a sharing data list storing file sharing data information of each IM user in an online file storage user data server;

an IM client transmits file sharing data information of the file shared by the IM client with friends to the online file storage access server;

the online file storage access server storing the file sharing data information in a sharing data list stored in the online file storage user data server.

A method for implementing file virtual copying in a communication system implementing online file storage based on an IM platform includes:

an IM client A transmitting a virtual copying request to an online file storage access server, after an IM user A chooses to virtually copy a file shared by an IM user B to an online file storage of the IM user A via the IM client A;

the online file storage access server reads user information of the IM user B from the online file storage user data server of the IM user B. and finds a source file to be copied by the IM user A from the online file storage server according to the user information;

the online file storage server generates a virtual file according to the source file, and returns virtual file information to the IM client A via the online file storage access server.

A method for implementing online playing AV files in a communication system implementing online file storage based on an IM platform includes:

an online file storage access server reads an AV file chosen to be played online by an IM user from an online file storage server;

the online file storage access server copies the AV file to a flow media server, generates and returns a playing list file to an IM client; and

the IM client calls a local media player to play the file in the file list.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a communication system for implementing online file storage based on an IM platform in accordance with the present invention.

FIG. 2 is a flowchart of the method for storing a file on the online file storage in accordance with a first preferred embodiment of the present invention.

FIG. 3 is a flowchart of the method for sharing a file on the online file storage in accordance with a second preferred embodiment of the present invention.

FIG. 4 is a schematic diagram illustrating an interaction between an online file storage user data server of a sharing user and an online file storage user data server of a shared user.

FIG. 5 is a schematic diagram illustrating the communication system in accordance with a fourth preferred embodiment of the present invention.

FIG. 6 is a flowchart of the method for online playing AV files in accordance with the fourth preferred embodiment of the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It can be seen from the above that the communication system and method for implementing online file storage provides an online file storage service on the IM platform through combining the technologies of IM system and online file storage. Thus, a user can implement various online storage operations such as file storing, deleting, sharing, copying and the like through the existed IM client, without downloading a special online file storage client. By doing so, the operation is simple, and functions and storing and reading speeds the same as the ones provided by the online storage in the special client-based mode can be gained.

Additionally, since the virtual file generated during the procedure of copying is only a file including the physical address of the source file and an operation authority, according to the method for implementing virtual copying in online file storage based on an IM platform, the size of the generated virtual file is so small that it does not occupy too many storage spaces, and can reduce the time spending for copying.

Lastly, according to the method for playing AV files online based on the online file storage service of the IM platform, a user is allowed to online listen to and watch AV files stored in the online file storage or shared by IM friends conveniently as long as logging on his/her own online file storage anywhere, thereby omitting the step of downloading and the like and therefore greatly satisfying the requirements of users to implement multimedia services.

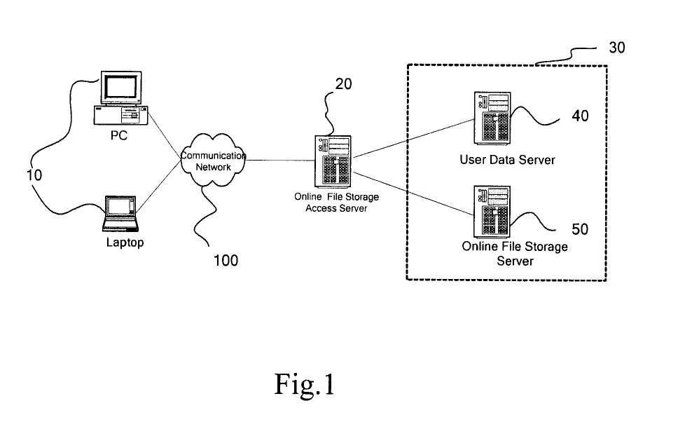

An embodiment of the present invention provides a communication system for implementing online file storage based on an IM platform. Referring to FIG. 1, the communication system mainly includes an IM client 10, an online file storage access server 20, and an online file storage server 30.

The IM client 10 can be installed on a personal computer (PC) or a laptop, and accesses a communication network 100 through means of wired or wireless communication, to provide an online file storage operation interface for users to facilitate them in choosing various online storage operations.

The online file storage access server 20 also accesses the communication network 100, mainly parsing IM protocols, verifying user online storage identifiers, processing user request logics and providing diverse services for users according to service classes to which the users belong.

The online file storage server 30 accesses the online file storage access server 20, mainly storing user files which are stored by users in the online file storage, processing such online storage operation requests as storing, deleting, sharing, copying, etc., and implementing such online storage operations to user files.

The online file storage server 30 can be further divided, according to functions, into an online file storage user data server 40 and an online file storage server 50 which all access the online file storage access server 20.

The online file storage user data server 40 mainly servers to store user data related with users other than user files in the online file storage, and the user data includes: directory structures of the user files in the online file storage, user identifiers, access count, etc., and the online file storage user data server 40 further serves to update the user date stored according to the operation results of implementing storing, deleting, sharing, copying, etc. on the user files.

The online file storage server 50 is mainly used to store the user files in the online file storage, process requests from the online file storage access server 20 such as file storing, deleting, sharing, copying, etc., to implement storing, deleting, sharing, copying, etc. for the files in the online file storage.

With expansion of domains and numbers of the users, there can be multiple online file storage data servers 40 each of which is used for storing user data of different users. The online file storage access server 20 interacts with each online file storage user data server through a uniform data interface.

According to the above communication system, users can store, delete or copy the files in the online file storage by directly clicking the online file storage operation interface of the IM client 10. After the users choose one of the above operations, the IM client 10 transmits a corresponding request message to the online file storage access server 20 via the communication network 100; and the online file storage server 20 parses the received request message and interacts with the online file storage server 30 according to the user's request, that is, interacting with the online file storage user data server 40 and the online file storage server 50 respectively, to implement such online storage operations as file storing, deleting, sharing, copying, or the like on the file.

Online storage methods for implementing storing, deleting, sharing as well as copying on a file on the online file storage will be hereunder described in detail through specific preferred embodiments.

The first preferred embodiment:

The method for implementing such traditional online storage operations as file storing, deleting, copying, and the like on the online file storage based on the IM platform is described in the embodiment.

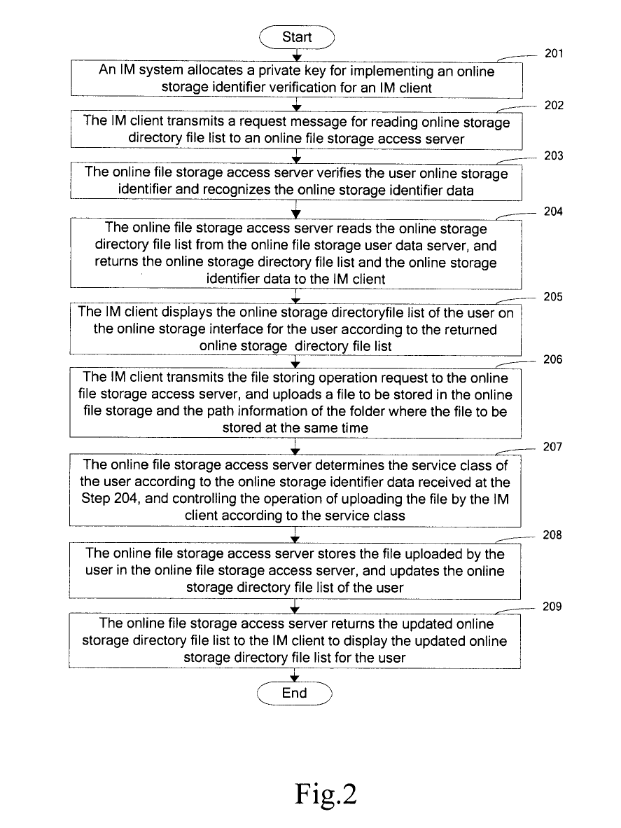

FIG. 2 is a flowchart of the method for storing a file in the online file storage in accordance with the first preferred embodiment of the present invention. As shown in FIG. 2, the method mainly includes the following steps:

Step 201: after a user logs on an IM system by an IM client, the IM system implements identifier verification for the IM client, and allocates a private key for implementing an online storage identifier verification for the IM client.

Step 202: the IM client transmitting a request message for reading online storage directory file list to the online file storage access server when the user clicks an online file storage interface of the IM client to open the online file storage, and carries the logging-on name of the user and the private key allocated by the IM system for the IM client in the request message.

Step 203: the online file storage access server verifies the user online storage identifier according to the logging-on name and private key carried in the request message for reading online storage directory file list, and recognizes the online storage identifier data corresponding to the user; wherein the online storage identifier includes a service class to which the user belongs, for example the user is a member user or not, and the like.

Step 204: the online file storage access server acquires the online storage directory file list of the user from the online file storage user data server, and returns the acquired online storage directory file list of the user and the recognized online storage identifier data corresponding to the user to the IM client.

Step 205: the IM client displays the online storage directory file list for the user on the online storage interface according to the returned online storage directory file list.

Step 206: the IM client transmits correspondingly a file storing operation request to the online file storage access server, and uploads the file to be stored in the online file storage and the path information of the folder where the file is to be stored at the same time, when the user chooses to store some file in a certain folder in the online file storage via the online file storage operation interface of the IM client.

Step 207: the online file storage access server determines the service class of the user according to the online storage identifier data received at the Step 204, and controlling the operation of uploading the file by the IM client according to the service class.

The service class includes a speed limitation for storing the file, a size limitation for the file to be uploaded, a number of uploading per day, etc.

Step 208: the online file storage access server interacts with the online file storage server to store the file uploaded by the user at the corresponding location on the online file storage server according to path information of the folder chosen by the user; further the online file storage access server interacts with the online file storage user data server to update the online storage directory file list of the user according to the path information of the folder chosen by the user.

Step 209: the online file storage access server returns the updated online storage directory file list to the IM client which will display the updated online storage directory file list on the online file storage operation interface for the user.

By far, the user has stored the file at the designated location on the online file storage, that is, establishing a connection between the file name displayed on the IM client and the file stored in the online file storage server. The user can therefore browse the stored file by clicking the file name displayed on the online file storage operation interface of the IM client.

During the procedure of storing a file, the online file storage access server, comparing with the online file storage user data server and the online file storage server, functions as a client to store the file uploaded by the user at the designated location on the online file storage server, and update the online storage directory file list of the online file storage user data server, and the online file storage access server interacts with the online file storage user data server and the online file storage server via connections established.

Further, the online file storage access server and the IM client all cache the file to be stored by the user so as to avoid some problems occurring during the procedure of storing. The online file storage server will directly re-ask the online file storage access server for the file to ultimately implement the storage operation for the file, if a file storing failures.

After the above-mentioned Step 205, the user can implement basic online storage operations such as choosing to delete the existed file in the online file storage, or choosing to copy the existed file in the online file storage to a local hard-disk, or the like through the online file storage operation interface of the IM client.

Upon receiving the above-mentioned online storage operation request, the IM client transmits the operation request to the online file storage access server via the communication network, and implements the various online storage operations requested by the user by the interaction between the online file storage access server and the online file storage server, for example, deleting the file in the online file storage server, or copying the file to the local disk where the IM client is located, or the like. Meanwhile, the online file storage access server need to interact with the online file storage user data server to update the online storage directory file list of the user stored in the online file storage user data server. During the procedure of the above-mentioned online storage operation, the procedure of the interaction between the IM client and the online file storage access server, the procedure of the interaction between the online file storage access server and the online file storage server, and the procedure of the interaction between the online file storage access server and the online file storage user data server are basically the same as the procedure of interaction illustrated in the procedure of storing a file in FIG. 2, so there is no more description.

It can be seen from the above that a user can implement basic online storage operations such as traditional file storing, deleting, copying, etc. by simply using the online file storage operation interface provided by the IM client, and can acquire the online file storage functions and the storing and reading speed without downloading the specific online file storage client software, according to the online storage method described in the first preferred embodiment.

The second preferred embodiment:

Since sharing a file is also a basic operation among file operations, a detailed description of the method for sharing a file in the online file storage with other IM friends based on the IM platform is given in the second preferred embodiment.

The method for sharing a file in the online file storage based on the IM platform and given in the embodiment is a third party sharing technology based on the IM platform, providing a function of sharing a file in the online file storage. By using the method described in the embodiment, a user can share a folder stored in the online file storage with IM friends of the user.

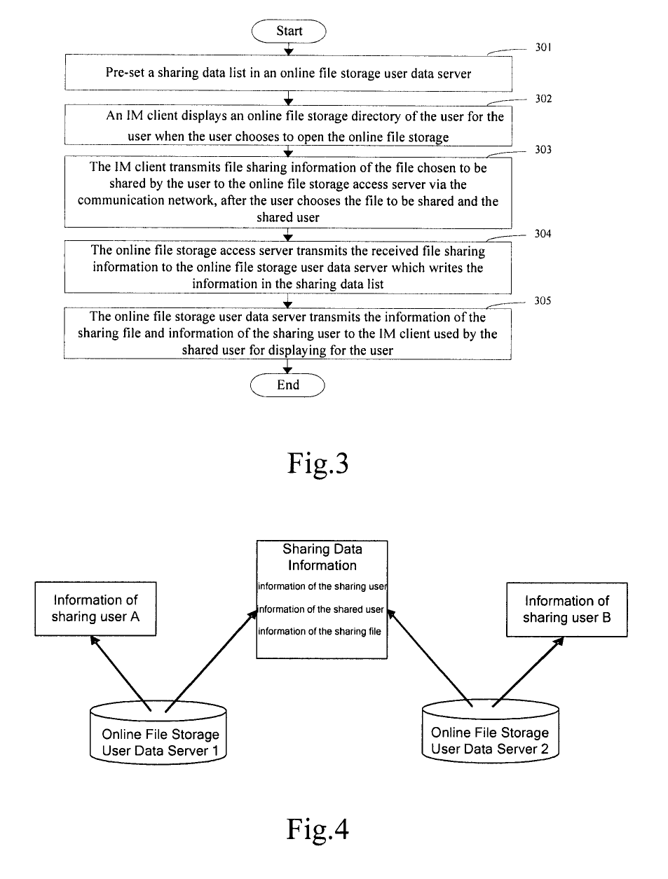

FIG. 3 shows a flowchart of the method for sharing a file in the online file storage in accordance with the second preferred embodiment of the present invention. As shown in FIG. 3, the method mainly includes the following steps:

Step 301: a sharing data list is pre-set in an online file storage user data server, wherein the sharing data list is used to store file sharing data information of each IM user.

And the file sharing data information mainly includes information of the user sharing the file (called sharing user for brief), information of the folder to be shared (called sharing folder for short), and information of the user whose file is shared (called shared user for short).

Step 302: the IM client displays the online storage directory of the user for the user on the online file storage operation interface, after the user logs on the IM system by the IM client and chooses to open the online file storage.

And the implementing method of the step is the same as the method described in the Steps 201 through 205 in the first preferred embodiment.

Step 303: after the user chooses the sharing folder and the shared user via the online file storage operation interface of the IM client, the IM client transmits the file sharing data information of the sharing file chosen to be shared by the user, which includes information of the sharing folder, information of the sharing user and information of the shared user to the online file storage access server through the communication network.

Step 304: the online file storage access server transmits the received file sharing data information to the online file storage user data server which writes the above-mentioned information to the sharing data list; wherein before Step 304, the online file storage access server further checks the authority of the sharing user; if the sharing user is authorized to share the file with the shared user, proceeds to Step 304; otherwise, the sharing user is rejected to implement the sharing file operation;

Step 305: an online file storage user data server transmits the information of the sharing file and information of the sharing user in the file sharing data information to the IM client used by the shared user via the online file storage access server, to display the information of the sharing user and the sharing folder shared by the sharing user on the online file storage operation interface of the IM client.

By doing so, a connection between the sharing folder name displayed on the IM client of the shared user and the file stored in the online file storage server of the sharing user is established. Therefore, the shared user can choose to read or download the sharing file shared by the sharing user by clicking the sharing folder displayed on the online file storage operation interface.

In Step 305, if there are more online file storage user data servers, and the online file storage user data server of the sharing user and the online file storage user data server of the shared user are different, the online file storage server of the sharing user has to transmit the information of the sharing file, information of the sharing user and information of the shared user to the online file storage user data server of the shared user which transmits the file sharing data information to the IM client of the shared user.

The schematic diagram illustrating the above interaction between the online file storage user data server of the sharing user and the online file storage user data server of the shared user is as shown in FIG. 4. In FIG. 4, user information of sharing user A is stored in online file storage user data server 1, while user information of shared user B is stored in online file storage user data server 2. Both of the online file storage user data server 1 and the online file storage user data server 2 store the same file sharing data information shared by the sharing user A and the shared user B. Those skilled in the art should appreciated that the consistency of the file sharing data information in each online file storage user data server is beneficial to simplification of the file sharing processing and improvement of the processing efficiency.

Although there may be multiple online file storage user data servers in the method in accordance with the embodiment, uniform data interfaces are adopted between the online file storage access server and the online file storage user data servers. This processing of using uniform data interfaces makes the processing of the data stored in different servers same as the processing of the data stored in one online file storage user data server. As such, the user data of the sharing user and the shared user can be respectively stored in different online file storage user data servers, which fully guarantees the volume of the system. Meanwhile, the data security is also assured by storing the information of the sharing file, information of the shared user and sharing data information respectively in the online file storage server and the online file storage user data server.

After Step 305, the IM client of the sharing user can directly read corresponding file sharing data information from the online file storage user data server of the sharing user via the online file storage access server, and return the file sharing data information to the IM client of the sharing user to display the acquired file sharing data information thereon for the sharing user, if the sharing user wants to query about the users who share the directory.

The IM client of the shared user can directly read file sharing data information from the online file storage user data server of the shared user via the online file storage access server, and return the file sharing data information to the IM client of the shared user to display the acquired file sharing data information thereon for the shared user, if the shared user wants to query about the users who share the directory.

If the shared user needs to download a file stored in the sharing folder shared by the sharing user, the IM client of the shared user reads file sharing data information from the online file storage user data server of the shared user via the online file storage access server to acquire the information of the sharing user; then the online file storage access server acquires the online storage directory file list of the sharing user from the online file storage user data server where the sharing user is located, and then reads the file from the designated location at the corresponding online file storage server, and returns the file to the client of the shared user. The above procedure is the procedure of the shared user downloading the sharing file shared by the sharing user.

During the procedure of downloading the sharing file, a user can adopt a transport protocol which is the same as the existing one used by online file storages. Since the existing transport protocol used by online file storages supports breakpoint resume transmission, and allows moderate data redundancy, the repeated call for data during the procedure of data query can be reduced, thereby accelerating the speed of forward and reverse data querying.

According to the method in accordance with the present invention, the number of IM client friends can also be automatically determined, and a threshold can be set at the column of the sharing friend number set by the sharing user. Once the number of the friends chosen to be shared a file with the user exceeds the threshold, an updating procedure is automatically implemented to update the friend list of the IM client.

According to the method in accordance with the present invention, a user can directly set the file to be shared with the IM friends via the online file storage operation interface of the IM client. For example, after an IM user chooses some folders displayed on the online file storage operation interface by clicking the right button of the mouse, the IM client has indeed called the local friend data of the IM system during the procedure of popping up a dialog box. The user can share the folder with the chosen friends by directly choosing the corresponding friends. It can be seen from the above that the method in accordance with the present invention provides a convenient way for sharing data, greatly facilitating the IM friends in sharing information.

The third preferred embodiment:

In the second preferred embodiment, the processing of downloading a file from the sharing folder of a friend is implemented according to a traditional manner of downloading a file, that is, directly and completely copying the sharing file to a local hard-disk or an online file storage. Those skilled in the art should understand that a great many of storage spaces on the online file storage or the local hard-disk will be occupied repeatedly when the traditional copying method is used. Meanwhile, since the whole file is needed to be copied completely, the procedure of the above downloading will spend a lot of time.

The third preferred embodiment in accordance with the present invention gives a virtual copying method which can enable an IM user to virtually copy the sharing file of an IM friend to online file storage or local disk of the IM user, or copy a file in the online file storage to the sharing folder of the IM friend. This virtual operation not only saves storage spaces, but also reduces the time spending on the procedure of copying.

The virtual copying mentioned in the embodiment is a new manner of copying network files. For the user, the virtual copying operation has no difference from the traditional operation of copying a file. But for the storage system, the two kinds of operation are absolutely different. For a brief description, the file to be copied is called a source file; and the copied file is called a virtual file.

In a normal condition, source codes of the source file include two parts: a header and a text. The header includes a physical address and a control authority. Thus, the header and text can be divided during the procedure of generating a virtual file, and directly copy the header to generate the virtual file. Since the virtual file includes the information of the physical address of the source file, the source file can be found according to the information of the physical address included in the virtual file, that is, a reference of the source file, and the virtual file is connected to the source file through a manner of hard-connection. So, according to the method for generating a virtual file, the online file storage server can directly find the source file according to the address of the source file recorded in the virtual file when the user accesses the copied virtual file.

As the operation of the above virtual copying does not need to copy the whole source file, but just generates a file including the physical address and the operation authority of the source file instead, the size of the generated virtual file is very little without occupying too much storage spaces. In addition, the procedure of copying can be finished instantaneously as the size of the virtual file is small, saving the time spending on copying.

The main operations of the virtual copying include such operations as file copying, reading, deleting, etc., and the detailed procedure of implementing such operations is as the follows.

1) copying:

when an IM user B chooses to copy a sharing file shared by an IM user A to its own online file storage via an online file storage operation interface of IM client B, the IM client B transmits a virtual copying request to the online file storage access server; the online file storage access server first checks whether the IM user B is authorized to read the sharing file of the IM user A; if the communication user B is authorized to read the sharing file of the IM user A, the online file storage access server requests according to the request of the IM user B the online file storage server of the IM user A to generate a virtual file according to the sharing file of the IM user A, and returns the generated virtual file name, the address information, and so on to the IM user B via the online file storage access server; the IM client B of the IM user B displays the returned virtual file name on the online storage directory of the IM user B via the online file storage operation interface. At this time, a connection between the virtual file name displayed on the IM client of the IM user B and the virtual file stored in the online file storage server is established. After the online file storage server generates the virtual file, the online file storage access server further need to update the online storage directory file list of the IM user B stored in the online file storage user data server of the IM user B.

If the IM user B is authorized to write in the sharing folder of the IM user A, the IM user B may also copy the file stored in its own online file storage to the sharing folder of the IM user A.

2) reading:

when the IM user B chooses to read some copied virtual file via the online file storage operation interface of the IM client B, the IM client B transmits a request for reading virtual file to the online file storage server via the online file storage access server; the online file storage server can find the source file according to the address of the source file recorded in the virtual file, and return the source file to the IM client B.

3) deleting:

If the IM user B wants to delete a virtual file stored in online file storage, the online file storage server directly deletes the established virtual file, and updates the online file storage file list of the IM user B stored in the online file storage user data server. At this moment, the IM user B can not see the deleted file on the IM client B. The IM user A however can still see the source file stored in online file storage on the IM client A.

If the IM user A wants to delete the source file stored in online file storage server, the online file storage server does not delete the source file stored in itself, but just updates the online storage directory list of the IM user A in the online file storage user data server instead, and the IM user A thus can not see the deleted file through the IM client A. The operation just deletes the connection between the file name displayed on the IM client A and the source file stored in the online file storage server. At this time, the IM user B can still see copied file on the IM client B.

Only when all virtual files and connections pointing to the source file are deleted, that is, the reference number of the source file is zero; the online file storage server will delete the source file.

The fourth preferred embodiment:

Along with development of multimedia services and requirements of users for multimedia services, more and more users wish that the online file storage can provide a function of playing AV files online to facilitate the users in listening to songs or watching video programs everywhere without downloading same files repeatedly, wherein the songs and the video programs are stored in the online file storages of the users.

The fourth preferred embodiment in accordance with the present invention provides a communication system for playing AV files online on an online file storage based on an IM platform and a method thereof, to implement a function of individually playing audio video files by user, wherein the online file storage is in accordance with the one provided by the present invention.

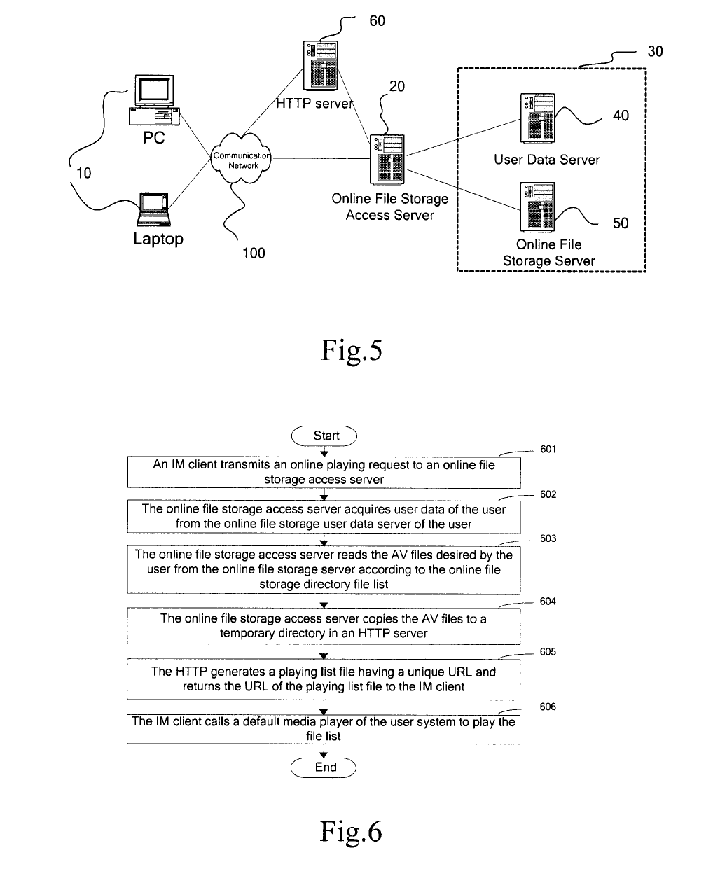

To implement the function of playing online, a flow media server 60 accessing the communication network 100 and the online file storage access server 20 is first needed to be added to the communication system illustrated in the present invention, which is used to temporarily store the AV files required playing online by the IM user, and generating a playing list file according to these AV files. The schematic diagram of the communication system illustrated in the embodiment is as shown in FIG. 5.

The flow media server mentioned in the embodiment can be an HTTP server or a Real server, or the like.

In the above-mentioned communication system, after an IM user logs on successfully, and chooses to online listen to an AV file through the online file storage operation interface of the IM client 10, the online file storage access server 20 reads the corresponding AV file from the online file storage server 50 of the user, and copies the file to the flow media server 60. The flow media server 60 generates and transmits a playing list file to the IM client 10. Then, the IM client 10 calls a default media player of the user system to play the AV file in the file list, thereby implementing one procedure of online playing.

FIG. 6 shows a flow chart of the method for implementing playing AV files online by using the communication system in accordance with the embodiment. As shown in FIG. 6, the method mainly includes the following steps:

Step 601: after an IM user logs on and chooses to play a certain online folder or some files via the online file storage operation interface of the IM client, the IM client transmits an online playing request to the online file storage access server, wherein the request carries the file name or folder name and the path information chosen by the user.

It should be clarified that the online files chosen by the IM user to be played must be the file stored in the online file storage. If the online files chosen by the IM user to be played are not the file stored in the online file storage, the IM user first needs to upload related files to the online file storage server. The method for uploading can use the method illustrated in the first preferred embodiment.

Step 602: the online file storage access server acquires user data of the user from the online file storage user data server of the user.

The user data mainly includes an IM account number of the user, information of the user, the online storage directory file list of the file stored in the online file storage server, and the like.

Step 603: the online file storage access server reads the AV file to be played by the user from the online file storage server according to the online storage directory file list information of the user.

Step 604: the online file storage access server copies the AV files to a temporary directory in the flow media server (an HTTP server or a Real server, or the like).

Step 605: the flow media server generates a playing list file having a unique Uniformed Resource Locator (URL), and returns the URL of the playing list file to the IM client.

Step 606: the IM client calls a default media player of the user system to play the file list.

It can be seen from the above that, according to the communication system for playing AV files online based on the online file storage service of the IM platform and the method thereof, a user is allowed to listen to and watch online AV files stored in the online file storage conveniently as long as logging on online file storage anywhere, thereby the step of downloading and the like are omitted and the user requirements of implementing multimedia services are satisfied.

Additionally, those skilled in the art should understand that the method illustrated in the embodiment is allowed to play the AV files shared by an IM friend or the AV files copied from the sharing file of an IM friend in the virtual copying manner, through combining the methods of the embodiment with the methods illustrated in the second and third preferred embodiments. And the method for playing the above files is basically the same as the method illustrated in the embodiment. But it should be noted that, during the procedure of playing the AV files shared by an IM friend, the online file storage access server needs to first find the online file storage user data server where the sharing user is located according to the file sharing data information shared by the sharing user to acquire the user data of the sharing user, and the sharing user is the IM friend. Then the online file storage access server can find the AV file, which is the source file, shared by the sharing user from the online file storage server. During playing the file virtually copied, the online file storage server needs first find the source file stored by itself according to the information of the address of the source file included in the virtual file, and then copy the source file to the flow media server.

What is claimed is:

1. A communication system for implementing online file storage based on an instant messaging (IM) platform, comprising: an IM client accessing a communication network and an online file storage access server accessing the communication network, and an online file storage server accessing the online file storage access server;
wherein the IM client is used to provide an online file storage operation interface;
the online file storage access server is used to parse an IM protocol, verify a user online storage identifier and process a user request logic from the IM client; and
the online file storage server is used to store files in the online file storage and directory information, and process a file request from the online file storage access server.

2. The communication system of claim 1, wherein the online file storage server further comprises: at least one online file storage user data server and at least one online file storage server, accessing the online file storage access server,
wherein the online file storage user data server is used for storing user data related with the user, and updating the user data stored according to a result of implementing the file operations; and
the online file storage server is used for storing user files in the online file storage, and processing the file request from the online file storage access server.

3. The communication system of claim 2, wherein the communication system comprises two or more than two online file storage user data servers; and the online file storage access server interacts with each online file storage user data server via a uniform data interface.

4. The communication system of claim 1, further comprising: a flow media server which is used for accessing the communication network and the online file storage access server, and is used for temporarily storing audio video (AV) files to be played online by an IM user and generating a playing list.

5. The communication system of claim 1, wherein the IM client accesses the communication network via wired or wireless communication.

6. A communication system for online playing audio video (AV) files in an online file storage based on an instant messaging (IM) platform, comprising: an IM client accessing a communication network and an online file storage access server accessing the communication network, an online file storage server accessing the online file storage access server, and a flow media server accessing the communication network and the online file storage access server;
wherein the IM client is used to provide an online file storage operation interface via which a user chooses online playing operations, and start a local media player to play the files in the list;
the online file storage server is used to store files in the online file storage and the user data;
the online file storage access server is used to process an online playing request of the user; and
the flow media server is used to temporarily store AV files to be played online by the IM user, generate and return a playing list to the online file storage access server.

7. The communication system of claim 6, wherein the online file storage server further comprises: at least one online file storage user data server accessing the online file storage access server and at least one online file storage server accessing the online file storage access server;
wherein the online file storage user data server is used for storing user data related with the user; and
the online file storage server is used to store user files in the online file storage.

8. The communication system of claim 6, wherein the flow media server is a Hyper Text Transport Protocol (HTTP) server or a Real server.

9. A method for implementing online file storage in a communication system implementing online file storage based on an instant messaging (IM) platform, comprising:
transmitting, by the IM client, a file request to an online file storage access server, after an IM user chooses to implement a file operation on a file in the online file storage via an IM client;
acquiring, by the online file storage access server, user data of the IM user according to the received file request from the online file storage user data server;
interacting, by the online file storage access server, with the online file storage server according to the acquired user data, implementing the file requested by the user, and updating the user data of the IM user in the online file storage user data server according to a result of the file operation; and
returning, by the online file storage access server, the result of the file operation to the IM client.

10. The method of claim 9, before the process of transmitting the file request, further comprising:
logging on the IM system, by the IM user, via the IM client;
implementing an identifier verification and recognizing online storage identifier data corresponding to the user, by the IM system;
transmitting, by the IM client, a request for reading online storage directory list to the online file storage access server;
acquiring, by the online file storage access server, an online storage directory file list of the user from the online file storage user data server, and returning the acquired online storage directory file list of the user and the recognized online storage identifier data corresponding to the user to the IM client for displaying.

11. The method of claim 10, upon the IM system recognizing online storage identifier data corresponding to the user, further comprising: returning, by the IM system, a private key to the IM client;
and carrying, by the IM client, a logging-on name and the private key in the request for reading online storage directory list; verifying, by the online file storage access server, the online storage identifier of the user according to the received logging-on name and the private key after the online file storage access server receives the request; if the verification is passed, proceeding with the process; otherwise, rejecting the request of the user.

12. The method of claim 9, wherein the user data further comprises: the online storage directory file list of the IM client.

13. The method of claim 9, wherein the file request comprises file storing, deleting, or copying operation request;
the process of transmitting the file request further comprises: transmitting, by the IM client, a file chosen by the IM user to be stored in the online file storage and path information for storing the file, or the information of file to be deleted or copied to the online file storage access server; and
the process of implementing the file requested by the user comprises: storing a file from the IM client in the online file storage server, or deleting from the online file storage server the file chosen by the IM user to be deleted, or reading the file chosen to be read by the IM user from the online file storage server and transmitting the file chosen to be read by the IM user to the IM client.

14. A method for sharing files in a communication system implementing online file storage based on an instant messaging (IM) platform, comprising:
pre-setting a sharing data list storing file sharing data information of each IM user in an online file storage user data server;
transmitting, by an IM client, file sharing data information of the file shared by the IM client with friends to the online file storage access server; and
storing, by the online file storage access server, the file sharing data information in a sharing data list stored in the online file storage user data server.

15. The method of claim 14, after the process of transmitting the file sharing data information, further comprising: checking, by the online file storage access server, an authority of a sharing user; if the sharing user is authorized to share the file with the shared user, proceeding with the process; otherwise, the sharing user is rejected to implement the sharing file operation and the process is terminated.

16. The method of claim 14, after the process of storing the file sharing data information, further comprising: transmitting, by the online file storage user data server, information of the sharing file and information of the sharing user in the file sharing data information to the IM client used by the shared user for displaying via the online file storage access server.

17. The method of claim 16, wherein the online file storage user data server of the sharing user is different from the online file storage user data server of the shared user;
and the process of the online file storage user data server transmitting the information of the sharing file and information of the sharing user in the file sharing data information comprises: transmitting, by the online file storage data server of the sharing user, the file sharing data information to the network had-disk user data server of the shared user; and transmitting, by the network had-disk user data server of the shared user, the file sharing data information to the IM client of the shared user for displaying.

18. The method of claim 14, wherein the file sharing data information comprises: information of the sharing user, information of the sharing file, and information of the shared user.

19. The method of claim 16, after the process of the online file storage user data server transmitting the information of the sharing file and information of the sharing user in the file sharing data information, further comprising: reading, by the IM client of the sharing user, the file sharing data information of the user from the online file storage user data server of the sharing user via the online file storage access server, and displaying the file sharing data information of the user for the sharing user, after the sharing user chooses to query sharing information; and
reading, by the IM client of the shared user, file sharing data information from the online file storage user data server of the shared user via the online file storage access server, and displaying the file sharing data information for the shared user, after the shared user chooses to query the sharing information.

20. The method of claim 16, after the process of the online file storage user data server transmitting the information of the sharing file and information of the sharing user in the file sharing data information, further comprising:
reading, by the IM client of the shared user, the file sharing data information from the online file storage user data server of the shared user via the online file storage access server, and acquiring information of the sharing user from the file sharing data information, after the shared user chooses to download a file in a sharing folder shared by the sharing user;
acquiring, by the online file storage access server, the online storage directory file list of the sharing user from the online file storage user data server where the sharing user is located;
reading, by the online file storage access server, according to the online storage directory file list information, the file from the designated location on the online file storage server; and
returning, by the online file storage access server, the file to the client of the sharing user for displaying.

21. A method for implementing file virtual copying in a communication system implementing online file storage based on an instant messaging (IM) platform, comprising:
transmitting, by an IM client A, a virtual copying request to an online file storage access server, after an IM user A chooses to virtually copy a file shared by an IM user B to an online file storage of the IM user A via the IM client A;
reading, by the online file storage access server, user information of the IM user B from the online file storage user data server of the IM user B, and finding a source file to be copied by the IM user A from the online file storage server according to the user information; and
generating, by the online file storage server, a virtual file according to the source file, and returning virtual file information to the IM client A via the online file storage access server.

22. The method of claim 21, before the process of reading user information of the IM user B and finding a source file, further comprising: checking, by the online file storage access server, whether the IM user A is authorized to read a file shared by the IM user B; if the IM user A is authorized to read the file shared by the IM user B, proceeding with the process; otherwise, forbidding the IM user A to copy the file and terminating the process.

23. The method of claim 21, wherein the process of generating a virtual file according to the source file comprises: dividing the source file into a header and a text, and copying the header to generate the virtual file.

24. The method of claim 21, further comprising: transmitting, by the IM client A, a request for reading a virtual file to the online file storage server via the online file storage access server, after the IM user A chooses to read the virtual file; finding, by the online file storage server, the source file according to the address of the source file recorded in the virtual file, and returning the source file to the IM client A via the online file storage access server.

25. The method of claim 21, further comprising:
deleting, by the IM client A, the virtual file established in the online file storage server via the online file storage access server, and updating user data of the IM user A in the online file storage user data server, after the IM user A deletes the virtual file stored in online file storage of the IM user A;
deleting, by the IM client B, source file information in user information stored by the IM user B in the online file storage user data server, after the IM user B deletes the source file stored in the online file storage server of the IM user B; and
deleting the source file when the online file storage server of the IM user B detects that a reference number of the source file is zero.

26. A method for implementing online playing audio video (AV) files in a communication system implementing online file storage based on an instant messaging (IM) platform, comprising:
reading, by an online file storage access server, an AV file chosen to be played online by an IM user from an online file storage server;
copying, by the online file storage access server, the AV file to a flow media server, generating and returning a playing list file to an IM client; and
calling, by the IM client, a local media player to play the file in the file list.

27. The method of claim 26, wherein the process of returning a playing list file to an IM client comprises: returning a Uniformed Resource Locator (URL) of the generated playing list file to the IM client.

28. The method of claim 26, before the process of reading the AV file chosen to be played online, further comprising: transmitting, by the IM client, an online playing request to the online file storage access server, after the IM user chooses to play the file online in the online file storage via the IM client.

29. The method of claim 26, wherein the file chosen to be played online by the IM user is a virtual file; and
the process of reading the file chosen to be played online by the user from the online file storage server comprises: finding the virtual file chosen to be played by the user from the online file storage server, and reading a source file from the online file storage server according to the address of the source file recorded in the virtual file.

30. The method of claim 26, wherein the file chosen to be played online by the IM user is a file shared by an IM friend; and
the process of reading the file chosen to be played online by the user from the online file storage server comprises: acquiring the file sharing data information shared by the IM friend from the online file storage user data server of the user to acquire the online file storage user server where the IM friend is located, and acquiring a source file of the IM friend from the online file storage user server where the IM friend is located.
